(19) United States
(12) Patent Application Publication
(10) Pub. No.: US 2025/0232562 A1
(43) Pub. Date: Jul. 17, 2025

(54) METHOD FOR CLASSIFYING POINTS WITHIN POINT CLOUDS WITH THREE OR MORE DIMENSIONS

(71) Applicant: Robert Bosch GmbH, Stuttgart (DE)

(72) Inventors: Christian Behrens, Tuebingen (DE); Jannik Steinkamp, Muenchen (DE); Rolando Moreira, Porto (PT); Tiago Martins, Braga (PT)

(21) Appl. No.: 19/010,296

(22) Filed: Jan. 6, 2025

(30) Foreign Application Priority Data
Jan. 12, 2024 (DE) 10 2024 200 302.6

(51) Int. Cl. G06V 10/764; G01S 17/894; G01S 17/93; G06T 15/10; G06V 20/56

(52) U.S. Cl. CPC G06V 10/764; G01S 17/894; G01S 17/93; G06T 15/10; G06V 20/56; G06T 2210/56

(57) ABSTRACT

A method for classifying points within point clouds with three or more dimensions. The method includes: providing a measured value data set with three or more dimensions; forming a plurality of two-dimensional images from the three-dimensional or higher-dimensional measured value data set; assigning at least one measured value of the measured value data set with three or more dimensions to a pixel in an image of the plurality of two-dimensional images; classifying a type of pixel in the plurality of two-dimensional images; projecting the type of pixel onto the measured value in the measured value data set with three or more dimensions.

### CROSS REFERENCE

The present application claims the benefit under 35 U.S.C. § 119 of German Patent Application No. DE 10 2024 200 302.6 filed on Jan. 12, 2024, which is expressly incorporated herein by reference in its entirety.

### FIELD

The present invention relates to a method for classifying points within point clouds with three or more dimensions, to a computer program, to a machine-readable storage medium and to a vehicle.

### BACKGROUND INFORMATION

There are currently a variety of different solutions for classifying measured values in the vehicle sector. Due to the increasing number of measurement systems, in particular LiDAR measurement systems, as well as the increased demands of autonomous driving, the need for innovative and robust methods for classifying measured values in the vehicle sector is continuously increasing.

The constant increase in complexity in the vehicle sector with high efficiency requirements and increasing competition are creating cost pressure, and therefore cheaper and more efficient systems for vehicles are in greater demand.

### SUMMARY

A method according to the present invention for classifying points within point clouds with three or more dimensions may have an advantage over the conventional methods that the method uses all reflections in a point cloud so that both more points can be used or more reflections can be used and their classification can be taken into account in different contexts, which can lead to a better result. More preferably, the required computing capacity for classifying measured values, in particular LiDAR measured values, is significantly reduced. More preferably, the processing time can be parallelized by using two-dimensional images in neural networks, thus significantly reducing processing time. More preferably, artifacts in the point cloud can be better filtered out.

This is achieved according to an example embodiment of the present invention in that the method for classifying points within point clouds with three or more dimensions comprises the steps of:
providing a measured value data set with three or more dimensions,
forming a plurality of two-dimensional images from the three-dimensional or higher-dimensional measured value data set,
assigning at least one measured value of the measured value data set with three or more dimensions to a pixel in an image of the plurality of two-dimensional images,
classifying a type of pixel in the plurality of two-dimensional images,
projecting the type of pixel on the measured value in the measured value data set with three or more dimensions.

In other words, by means of converting the three-dimensional or multi-dimensional point cloud into two-dimensional images, the classification or segmentation by means of an artificial neural network can be significantly simplified. For example, with LiDAR sensors or the like, a plurality of beams that can be detected by means of the LiDAR sensor can be transmitted. The reflections can be evaluated using the time-of-flight or the like. Furthermore, a transmitted beam can be reflected many times, which can lead to ambiguity when converted into a two-dimensional image. By using a variety of two-dimensional images, this ambiguity can be resolved. In particular, detected objects that are obscured by artifacts such as raindrops can still be classified. Preferably, the artifacts can be recognized or filtered out by semantic segmentation without filtering out the detected objects, which can be obscured by the artifacts, for example. Thus, robustness against artifacts is improved, while maintaining detectability of safety-relevant information.

Preferred developments of the present invention are disclosed herein.

According to an example embodiment of the present invention, preferably, the method further comprises the steps of:
assigning a plurality of measured values of the measured value data set with three or more dimensions to the pixel in each of the plurality of two-dimensional images,
adjusting a number of the plurality of two-dimensional images using the assigned plurality of measured values.

An advantage of this embodiment is that by adjusting the number of the plurality of two-dimensional images, possible ambiguities can be resolved by converting a three-dimensional point cloud into a two-dimensional image.

According to an example embodiment of the present invention, preferably, the method further comprises the steps of:
transmitting a signal by means of a sensor unit,
forming the measured value data set with three or more dimensions on the basis of a plurality of reflections based on the transmitted signal.

An advantage of this embodiment is that an ambiguity based on multi-reflections can be more easily resolved with active sensors. For example, the sensor unit can be a LiDAR sensor.

More preferably, according to an example embodiment of the present invention, the method further comprises the step of:
adjusting the plurality of reflections to reflections that meet a predetermined criterion.

An advantage of this embodiment is that only reflections that meet the predetermined criterion or are within a predetermined range are taken into account, so that the efficiency of the method can be further increased, since reflections that do not meet the criterion or are outside the predetermined range cannot be taken into account. For example, the predetermined criterion can be a spatial arrangement, an impulse property or the like. More preferably, adjusting the number of reflections can comprise reducing the number of reflections so that only the reflections that can be used for further processing are selected.

According to an example embodiment of the present invention, preferably, the number of two-dimensional images corresponds to the plurality of two-dimensional images of the adjusted plurality of reflections.

An advantage of this example embodiment is that a processing time by the artificial neural network is reduced, since it only processes two-dimensional images that have reflections that meet the predetermined criterion.

According to an example embodiment of the present invention, more preferably, the number of two-dimensional images each having a selected pixel is greater than a second number of measured values in the three-dimensional or multi-dimensional measured value data set for the selected pixel, wherein the method further comprises the step of:
projecting the three-dimensional or multi-dimensional measured value onto the selected pixel in a first two-dimensional image and onto the selected pixel in a second two-dimensional image.

An advantage of this embodiment is that sufficient measured values are available for each of the plurality of two-dimensional images.

According to an example embodiment of the present invention, more preferably, the method further comprises the step of:
classifying each pixel in the plurality of two-dimensional images.

An advantage of this embodiment is that a class or state can be ascertained for each pixel in order to be able to project it onto each measured value of the measured value data set with three or more dimensions. A further advantage of this embodiment is that a dense neighborhood relationship can be achieved, in particular to other measured values in the three-dimensional or multi-dimensional measured value data set, so that the results of the classification can be improved.

According to an example embodiment of the present invention, more preferably, the method comprises the steps of:
identifying a first classified pixel in a first two-dimensional image and the first classified pixel in a second two-dimensional image,
   wherein the first classified pixel in the first two-dimensional image and the first classified pixel in the second two-dimensional image are associated with a selected measured value of the three-dimensional or multi-dimensional measured value data set,
adjusting the classification of the measured value using a comparison between the classification of the first classified pixel in the first two-dimensional image and the classification of the first classified pixel in the second two-dimensional image.

An advantage of this embodiment is that an ambiguity can be resolved based on the comparison of the classifications. The predetermined function can, for example, be a sorting by means of the confidence of the classification, a property of the measured value and/or the like. More preferably, the predetermined function can be a voting mechanism based on the classifications.

According to an example embodiment of the present invention, more preferably, the method comprises the step of:
ascertaining a first state or a second state of each measured value using the adjusted classification of the measured values.

An advantage of this embodiment is that it can be ascertained using the first state or the second state whether it is a valid or invalid reflection. More preferably, the reflections that have the first state, in particular represent a valid reflection, are taken into account for further processing.

More preferably, according to an example embodiment of the present invention, the method comprises the step of:
projecting a classification onto the three-dimensional or higher-dimensional measured value if it has the first state.

An advantage of this embodiment is that only the classifications that represent a valid classification are projected onto the measured value. A further advantage is that subsequent processing of the measured values can be simplified.

More preferably, according to an example embodiment of the present invention, the method comprises the step of:
forming a partial data set based on the measured values that have the first state and/or the second state.

An advantage of this embodiment is that by forming a partial data set with only the valid measured values or with only the invalid measured values, these can be used to perform further analyses.

A further aspect of the present invention relates to a computer program which is configured to carry out steps of the method of the present invention, as described above and below.

A further aspect relates to a machine-readable storage medium on which the computer program of the present invention, as described above and below, is stored.

A further aspect of the present invention relates to a vehicle which is configured to carry out steps of the method of the present invention as described above and below, and/or wherein the vehicle has a machine-readable storage medium of the present invention, as described above and below.

### BRIEF DESCRIPTION OF THE DRAWINGS

In the following, exemplary embodiments of the present invention are described in detail with reference to the figures.

FIG. 1 shows a flow chart illustrating steps of the method according to one example embodiment of the present invention.

FIG. 2 shows a flow chart illustrating steps of the method according to one example embodiment of the present invention.

FIG. 3 shows a vehicle according to one example embodiment of the present invention.

### DETAILED DESCRIPTION OF EXAMPLE EMBODIMENTS

Preferably, all the same steps, units and/or elements in all figures are provided with the same reference signs.

FIG. 1 is a flow chart illustrating steps of the method 100 according to one example embodiment of the present invention.

The method 100 for classifying points within point clouds with three or more dimensions comprises the steps of:
providing S1 a measured value data set with three or more dimensions,
forming S2 a plurality of two-dimensional images from the three-dimensional or higher-dimensional measured value data set,
assigning S3 at least one measured value of the measured value data set with three or more dimensions to a pixel in an image of the plurality of two-dimensional images,
classifying S4 a type of pixel in the plurality of two-dimensional images,
projecting S5 the type of pixel onto the measured value in the measured value data set with three or more dimensions.

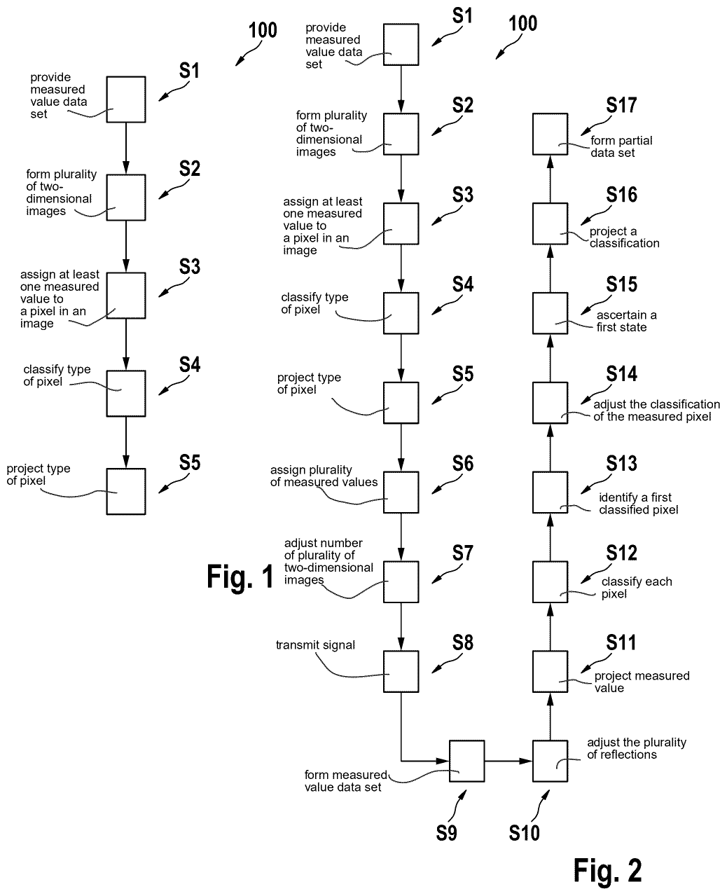

FIG. 2 is a flow chart illustrating steps of the method 100 according to one embodiment. The method 100 comprises the same or similar steps S1 to S5 as have already been explained with reference to FIG. 1. More preferably, the method 100 comprises the steps of assigning S6 a plurality of measured values and adjusting S7 a number of the plurality of two-dimensional images. Preferably, the method 100 further comprises the steps of transmitting S8 a signal and forming S9 the measured value data set. Preferably, the method 100 further comprises the step of adjusting S10 the plurality of reflections. Preferably, the method 100 further comprises the step of projecting S11 the three-dimensional or multi-dimensional measured value. Preferably, the method 100 further comprises the step of classifying S12 each pixel. Preferably, the method 100 further comprises the steps of identifying S13 a first classified pixel along with adjusting S14 the classification of the measured value. More preferably, the method 100 comprises the step of ascertaining S15 a first state. Preferably, the method 100 comprises the step of projecting S16 a classification. More preferably, the method 100 comprises the step of forming S17 a partial data set.

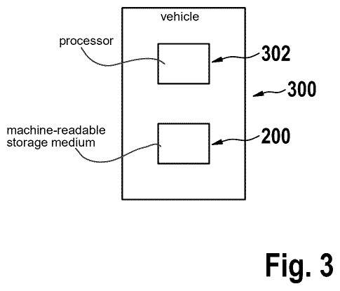

FIG. 3 shows a vehicle 300 according to one embodiment. Preferably, the vehicle 300 has a processor 302 or the like, which is configured to execute a computer program configured to carry out steps of the method 100, as described above and below. More preferably, the vehicle 300 has a machine-readable storage medium 200, as described above and below. In addition, the vehicle 300 can be configured to carry out steps of the method 100, as described above and below.

What is claimed is:

1. A method for classifying points within point clouds with three or more dimensions, comprising the following steps:
providing a measured value data set with three or more dimensions;
forming a plurality of two-dimensional images from the measured value data set with three or more dimensions;
assigning at least one measured value of the measured value data set with three or more dimensions to a pixel in an image of the plurality of two-dimensional images;
classifying a type of the pixel in the image of the plurality of two-dimensional images; and
projecting the type of pixel onto the measured value in the measured value data set with three or more dimensions.

2. The method according to claim 1, further comprising the following steps:
assigning a plurality of measured values of the measured value data set with three or more dimensions to a pixel in each of the plurality of two-dimensional images; and
adjusting a number of the plurality of two-dimensional images using the assigned plurality of measured values.

3. The method according to claim 1, further comprising the following steps:
transmitting a signal using a sensor unit; and
forming the measured value data set with three or more dimensions based on a plurality of reflections based on the transmitted signal.

4. The method according to claim 3, further comprising the following step:
adjusting the plurality of reflections to reflections that meet a predetermined criterion.

5. The method according to claim 3, wherein the number of two-dimensional images of the plurality of two-dimensional images corresponds to the adjusted plurality of reflections.

6. The method according to claim 5, wherein the number of two-dimensional images each having a selected pixel is greater than a second number of measured values in the three-dimensional or multi-dimensional measured value data set for the selected pixel, wherein the method further comprises the following step:
projecting measured value with three or more dimensions onto the selected pixel in a first two-dimensional image and onto the selected pixel in a second two-dimensional image.

7. The method according to claim 5, further comprising the following step:
classifying each pixel in the plurality of two-dimensional images.

8. The method according to claim 7, further comprising the following steps:
identifying a first classified pixel in a first two-dimensional image and the first classified pixel in a second two-dimensional image, wherein the first classified pixel in the first two-dimensional image and the first classified pixel in the second two-dimensional image are associated with a selected measured value of the measured value data set have three or more dimensions; and
adjusting the classification of the measured value using a comparison between the classification of the first classified pixel in the first two-dimensional image and the classification of the first classified pixel in the second two-dimensional image.

9. The method according to claim 7, further comprising the following step:
ascertaining a first state or a second state of each measured value using the adjusted classification of the measured values.

10. The method according to claim 9, further comprising the following step:
projecting a classification onto the measured value with three or more dimension when it has the first state.

11. The method according to claim 9, further comprising the following step:
forming a partial data set based on the measured values that have the first state and/or the second state.

12. A non-transitory machine-readable storage medium on which is stored a computer program for classifying points within point clouds with three or more dimensions, the computer program, when executed by a processor, causing the processor perform the following steps:
providing a measured value data set with three or more dimensions;
forming a plurality of two-dimensional images from the measured value data set with three or more dimensions;
assigning at least one measured value of the measured value data set with three or more dimensions to a pixel in an image of the plurality of two-dimensional images;
classifying a type of the pixel in the image of the plurality of two-dimensional images; and
projecting the type of pixel onto the measured value in the measured value data set with three or more dimensions.

13. A vehicle configured to classify points within point clouds with three or more dimensions, the vehicle configured to perform the following steps:
providing a measured value data set with three or more dimensions;
forming a plurality of two-dimensional images from the measured value data set with three or more dimensions;
assigning at least one measured value of the measured value data set with three or more dimensions to a pixel in an image of the plurality of two-dimensional images;
classifying a type of the pixel in the image of the plurality of two-dimensional images; and
projecting the type of pixel onto the measured value in the measured value data set with three or more dimensions.
